(19) United States
(12) Patent Application Publication
(10) Pub. No.: US 2013/0254014 A1
(43) Pub. Date: Sep. 26, 2013

(54) Automatic Information Placement

(71) Applicant: ALIBABA GROUP HOLDING LIMITED, Grand Cayman (KY)

(72) Inventor: Yunjiao Yao, Hangzhou (CN)

(73) Assignee: Alibaba Group Holding Limited, Grand Cayman (KY)

(21) Appl. No.: 13/849,285

(22) Filed: Mar. 22, 2013

(30) Foreign Application Priority Data
Mar. 26, 2012 (CN) 201210081544.6

(51) Int. Cl. G06Q 30/02

(52) U.S. Cl. CPC G06Q 30/0243
USPC 705/14.42

(57) ABSTRACT

The present disclosure introduces a method and an apparatus of automatic information placement. A server receives display location publishing information and determines a value index of a corresponding display location according to the received display location publishing information. When the server receives an information placement request, the server determines an investment index of corresponding placement information according to the received information placement request. The server compares one or more value indexes of display locations with one or more investment indexes of one or more placement information, and places respective placement information at a corresponding display location according to a comparison result. The present techniques improve the efficiency of placing information and optimizing resource deployment.

### CROSS REFERENCE TO RELATED PATENT APPLICATIONS

This application claims priority from Chinese Patent Application No. 201210081544.6 filed on 26 Mar. 2012 and entitled “Automatic Information Placement Method and Apparatus,” which is hereby incorporated in its entirety by reference.

### TECHNICAL FIELD

The present disclosure relates to the field of communication and, more specifically, to a method and an apparatus for automatic information placement.

### BACKGROUND

Electronic information placement refers to placing information provided by a placement information provider at a display location provided by a display location publisher at the Internet environment. During information placement, the display location publisher intends to make full use of the value of the display location by placing the most appropriate placement information to maximize benefits. Accordingly, the display location publisher needs to know the placement information as much as possible, including historical transaction information of a subject corresponding to the placement information, placement investment of the placement information, etc. In addition, the placement information provider intends to place the information at a most appropriate display location and to make maximum benefit through placing the placement information (i.e., obtaining a larger profit by a smaller placement investment). Thus, the placement information provider needs to know the display location information as much as possible, including access traffic of the display location and an investment required to place the information.

The conventional techniques require considerable human intervention for both the display location publisher to learn the placement information and the placement information provider to learn the display location information. Such information is obtained inefficiently. In addition, the amount of obtain information is typically small and the obtained information cannot be updated in a timely manner. Thus, the display location publisher and the placement information provider cannot obtain a sufficient amount of information for analysis and comparison, thereby causing inefficient investment, failing to optimize resources, and wasting networks resources and bandwidths.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method and an apparatus for automatic information placement to improve an efficiency of information placement and optimize resource deployment.

The present disclosure provides a method for automatic information placement. A server receives display location publishing information and determines a value index of a corresponding display location according to the received display location publishing information.

When the server receives an information placement request, the server determines an investment index of corresponding placement information according to the received information placement request.

The server compares one or more value indexes of display locations with one or more investment indexes of one or more placement information, and places respective placement information at a corresponding display location according to a comparison result.

The present disclosure also provides a server. The server includes a receiving unit, a determining unit, and a placing unit. The receiving unit receives display location publishing information and information placement request. The determining unit determines a value index of a corresponding display location according to the display location publishing information received by the receiving unit and an investment index of corresponding information according to the information placement request received by the receiving unit. The placing unit compares one or more value indexes of one or more display locations with one or more investment indexes of one or more placement information, and places respective placement information at a corresponding display location according to a comparison result.

In the present disclosure, the server determines the value index of the corresponding display location according to the received display location publishing information. When the server receives the information placement request, the server determines the investment index of the corresponding placement information according to the received information placement request, compares the value index of the display location with the investment index of the placement information, and places the placement information at a corresponding display location according to the comparison result, thereby improving the efficiency of information placement and optimizing the resource deployment.

### BRIEF DESCRIPTION OF THE DRAWINGS

To better illustrate the embodiments of the present disclosure, the following is a brief introduction of FIGs to be used in descriptions of the embodiments. It is apparent that the following FIGs only relate to some embodiments of the present disclosure. A person of ordinary skill in the art can obtain other FIGs according to the FIGs in the present disclosure without creative efforts.

FIG. 1 illustrates a diagram of an example system that applies an example method in accordance with the present disclosure.

FIG. 2 illustrates a flowchart of an example method for automatic information placement in accordance with the present disclosure.

FIG. 3 illustrates a diagram of an example server for automatic information placement in accordance with the present disclosure.

FIG. 4 illustrates another diagram of an example server for automatic information placement in accordance with the present disclosure.

### DETAILED DESCRIPTION

The present disclosure provides techniques for automatic information placement solution. The server receives display location publishing information, determines a value index of a corresponding display location according to the received display location publishing information. When the server receives an information placement request, the server determines an investment index of a corresponding placement information according to the received information placement request, compares value indexes of one or more display locations with investment indexes of one or more placement information, and places the placement information at a respective display location according to a comparison result, thereby improving the efficiency of information placement and optimizing resource deployment.

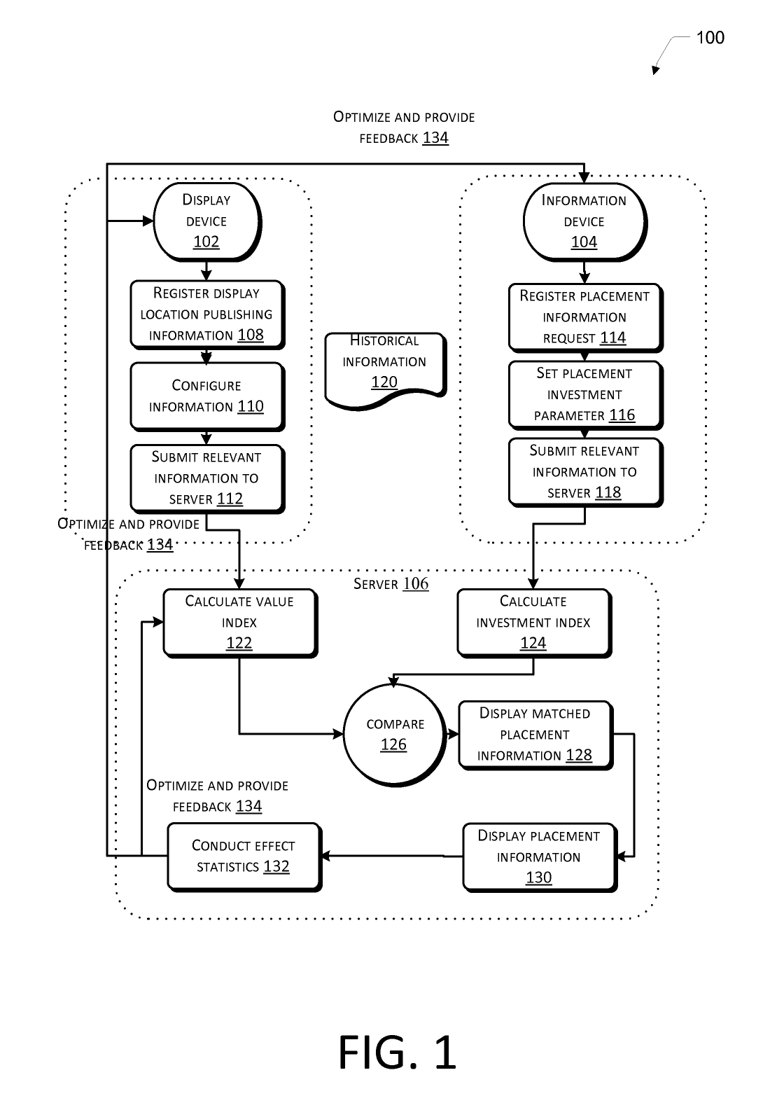

The present techniques are described in more detail by reference to the FIGs. An example method for automatically placing placement information under the present techniques may be applicable in a system 100 as shown in FIG. 1. The system 100 may include a display device 102 which is a client terminal device of a display location publisher, an information device 104 which is a client terminal device of a placement information provider of placement information to be published, and a server 106.

In the example of FIG. 1, the display device 102 may perform following operations. At 108, the display device 102 registers display location publishing information to the server 106. The display location publishing information includes display location information. The display location information may include one or any combination of basic information such as a size of the display location, a type of the display location, a traffic volume of the display location, etc. At 110, the display device 102 configures information such as a minimum placement investment parameter, historical transaction requirements, etc. At 112, the display device 102 submits the display location publishing information and other relevant information to the server 106.

In the example of FIG. 1, the information device 104 may perform the following operations. At 114, the information device 104 registers the placement information request. The placement information request may include the placement information and its corresponding placement investment parameter. The placement investment parameter may present a radio of an expense of the placement information provider for placing the placement information to revenue of the placement information provider from placing the placement information. The placement information may include one or any combination of the following information including a name, a type, and a price of a subject corresponding to the placement information. At 116, the information device 104 sets or configures the placement investment parameter. At 118, the information device 104 submits the placement information request and other relevant information to the server 106.

The display device 102 may submit display location publishing information of one or more display locations. The information device 104 may submit one or more information placement requests of one or more placement information. One or more historical information 120 may be used as references for the display location publishing information submitted through the display device 102 and the information placement requests submitted through the information device 104.

The server 106 receives the display location publishing information from the display device 102 and the information placement request from the information device 104 respectively. At 122, with respect to each display location publishing information submitted by the display device 102, the server 106 calculates a value index of the display location corresponding to the display location publishing information. For example, the server 106 may obtain historical information of the display location according to the display location information included in the received display location publishing information. The historical information of the display location may include one or any combination of the following information including historical access traffic of the display location, a user access type (e.g., normal browsing, clicking and viewing, etc.), historical transaction information of the subject corresponding to placement information placed at the display location, an historical placement investment parameter of the corresponding information, etc. The server 106 may determine the value index of the corresponding display location according to the obtained historical information of the display location and the display location information submitted by the display device 102.

For example, the server 106 may set corresponding investment parameter weights based on the size and the traffic of the display location respectively. For instance, a larger size of the display location corresponds to a higher weight and heavier traffic of the display location also corresponds to a higher weight. The server 106 may also obtain the transaction information of the subject corresponding to the placement information placed at the corresponding display location within a first preset time period (e.g., the past 7 days) and calculate a historical average yield of the display location according to the obtained transaction information and the placement investment parameter of the corresponding information. For instance, if information of two subjects (e.g., subjects A and B) in total has been placed at the display location during the past 7 days, the value index of the display location may be calculated by using a formula such that the average transaction amount of the subject A*the placement investment parameter A+the average transaction amount of the subject B*the placement investment parameter B. The server 106 may also determine the value index of the display location according to the average yield of the display location and the weights corresponding to the size and traffic of the corresponding display location by using a formula such that the value index=the average yield*the size weight of the display location*the traffic weight of the display location.

At 124, the server 106 calculates an investment index of the corresponding placement information. For example, the server 106 may obtain the historical information of the placement information according to the placement information included in the received information placement request. The historical information of the placement information may include one or any combination of the following information including historical information of the subject corresponding to the placement information, a historical placement investment parameter of the corresponding placement information, etc.

For instance, the server 106 may set corresponding investment parameter weights respectively based on a type and a price of the subject corresponding to the placement information. When the subject is a product, the weight of a clothing product may be set as 0.6, the weight of an electronic product may be set as 1, the weight of a vehicle product may be set as 1.5, and the weight corresponding to the price can be positively correlated to the price. A description of the configuration is not detailed herein. The server 106 may obtain historical transaction information of the subject of the corresponding placement information (such as a historical transaction amount of the corresponding subject) during a second preset time period (e.g., the past 7 days) and calculate the average investment of the subject of the corresponding placement information during the preset time period according to the obtained historical transaction information and the placement investment parameter of the corresponding placement information by using a formula such that the average investment=the average historical transaction amount*the placement investment parameter, where the average historical transaction amount may be the average value of the historical transaction amounts during the second preset time period, e.g., the historical transaction amounts divided by 7.

The server 106 determines the investment index of the placement information according to the average investment and the weights corresponding to the type and the price of the subject of the placement information by using a formula such that the investment index=the average investment*the type weight*the price weight.

With receipt of the display location publishing information, the server 106 determines the value index of the corresponding display location according to information of the received display location and uses the corresponding display location as a candidate display location. When the placement information provider intends to place corresponding placement information, the placement information provider may register at the server 106 (e.g., a website server, etc.) through the information device 104 and submit the information placement request to the server 106. With receipt of the information placement request, the server 106 determines the investment index of the information according to the received information placement request, and determines a corresponding display location at which to place the placement information according to value indexes of one or more candidate display locations.

In one example, the server 106 may obtain the historical information of the corresponding display location according to the received display location information, and obtain the historical information of the corresponding information according to the received information, through interacting with a database server that stores and manages data (not shown in FIG. 1).

For instance, the server 106 may send a request for historical information including a display location identifier to the database. With receipt of the historical information obtaining request, the database server searches the historical information of the corresponding display location according to the display location identifier carried in the request and returns the searched historical information to the server 106.

With respect to the display location or placement information that has no previous display record (i.e., no corresponding historical information of the display location or historical information of the placement information), the server 106 may determine the value index of the display location or the investment index of the placement information based on the display location information included in the received display location publishing information or the placement information included in the received information placement request respectively.

The first preset time period and the second preset time period may be the same or different.

At 126, after determining the value index of the corresponding display location and the investment index of the corresponding placement information, the server 106 compares the corresponding value index with the corresponding investment index. For instance, the server 106 may conduct a recursive or circular comparison. At 128, the server 106 displays matched placement information according to a result of the comparison.

At 130, the server 106 places the matched placement information at the corresponding display location. For example, the server may place the placement information at a display location with a highest value index and no less than the investment index of the corresponding placement information.

At 132, the server 106 conducts statistics of effects of the placement. At 134, the server 106 optimizes the method for placing information and provides feedbacks.

It should be understood that the above method for selecting a display location to place placement information is merely an example embodiment of the present disclosure. The present techniques may use other methods for determining the display location of the placement information, which are not detailed herein.

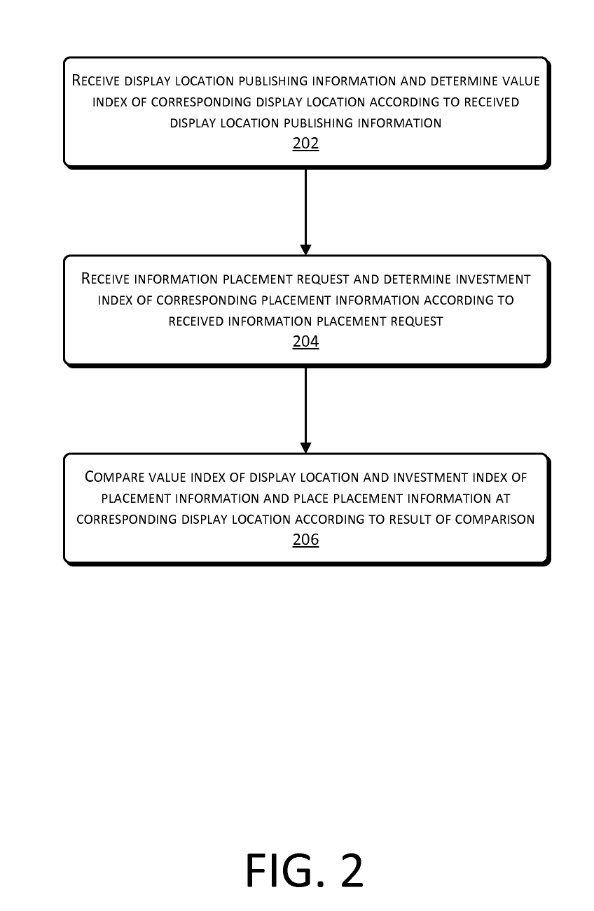

FIG. 2 illustrates a flowchart of an example method of automatic information placement in accordance with an example embodiment of the present disclosure.

At 202, a server receives display location publishing information and determines a value index of a corresponding display location based on the received display location publishing information.

For example, when receiving the display location publishing information, the server may obtain display location information carried in the display location publishing information, obtain historical information of the corresponding display location according to the display location information carried in the display location publishing information, and determine the value index of the corresponding display location according to the historical information of the display location and the display location information.

The display location information may include one or any combination of the following information including a size, a type, traffic, and other information of the display location. The historical information of the display location may include one or any combination of the following information including historical access traffic of the display location, a user access type, historical transaction information of the subject corresponding to the placement information placed at the display location, an historical placement investment parameter of the corresponding information, etc.

At 204, the server receives an information placement request and determines an investment index of corresponding placement information according to the received information placement request.

For example, after receiving the information placement request, the server obtains the placement information and the placement investment parameter of the placement information carried in the information placement request. The server obtains historical information of the placement information according to the placement information and determines the investment index of the placement information according to the historical information of the placement information, the placement information, and the placement investment parameter of the placement information.

The placement information includes one or any combination of the following information including a name of a subject corresponding to the placement information, a type of the subject corresponding to the placement information, a price of the subject corresponding to the placement information, etc. The placement investment parameter of the placement information is positively correlated to an investment provided by the placement information provider for placing the placement information. The historical information of the placement information includes one or any combination of the following information including historical transaction information of the subject corresponding to the placement information, a historical placement investment parameter of the corresponding placement information, etc.

At 206, the server compares the value index of the display location and the investment index of the placement information, and places the placement information at a corresponding display location according to a comparison result.

For example, the server may select the corresponding display location with a highest value index and no less than the investment index of the corresponding information among all candidate display locations to display the placement information.

For another example, in order to better guarantee the interests of the display location publisher, the display location publishing information submitted by the display device to the server may further carry one or more preset placement conditions that indicate one or more condition that shall be satisfied for the placement information to be placed at the corresponding display location.

The one or more preset placement condition may include one or any combination of the following including a minimum placement investment parameter, a minimum historical transaction amount, and a category of the subject corresponding to the placement information.

For example, when the preset placement condition is the minimum placement investment parameter, it may indicate that only placement information whose placement investment parameter is not less than the minimum placement investment parameter is permitted to be placed at the corresponding display location.

For another example, when the preset placement condition is the minimum historical transaction amount, it may indicate that only placement information whose corresponding subject's historical transaction amount is not less than the minimum historical transaction amount is permitted to be placed at the corresponding display location.

For another example, when the preset placement condition is the category of the subject corresponding to the information, it may indicate that only placement information whose category of the subject corresponding to the placement information is the preset category is permitted to be placed at the corresponding display location.

For another example, when the preset placement condition is the category of the subject corresponding to the placement information, it may also be used to indicate that only placement information whose category of the subject corresponding to the placement information is not the preset category is permitted to be placed at the corresponding display location.

For instance, the preset placement condition of a display location 1 may indicate that only placement information whose corresponding subject belongs to one or more specific categories (such as home appliance, vehicle, etc.) are permitted to be placed, or indicate that only placement information whose corresponding subject does not belong to one or more specific categories (such as toy, clothing, etc.) are permitted to be placed.

Correspondingly, in order to guarantee the interest of the placement information provider, the information placement request submitted by the information device to the server may further carry one or more preset to-be-placed conditions that indicate one or more conditions of the corresponding display location to which the placement information is placed shall satisfy. When determining that the corresponding display location satisfies the preset to-be-placed conditions according to the display location information submitted by the display device, the server compares the value index of the display location satisfying the preset to-be-placed conditions with the investment index of the information.

The one or more preset to-be-placed condition may include one or any combination of the following including a maximum placement investment parameter, a traffic volume of the display location, and a size of the display location.

In one example embodiment, to improve the flexibility in matching the placement information to the present placement condition and the display location to the preset to-be-paced condition, it may not be necessary to require the pair of the information and the display location to match all preset placement conditions and preset to-be placed conditions and the pair of the information and the display location may only need to match a portion of all preset placement conditions and preset to-be placed conditions.

For example, the server may determine whether the placement information satisfies the preset placement conditions according to the placement information by any of the following methods.

In a first method, the server matches the placement information with each of the preset placement conditions. If a percentage of a number of successfully matched preset placement conditions to a total number of the preset placement conditions is higher than a first threshold, the server determines that the corresponding placement information satisfies the preset placement conditions.

In a second method, the server ranks priorities of the placement conditions from high to low and matches the placement information to the placement conditions in an order of descending priorities of the placement conditions. When a number of successfully matched preset placement conditions is higher than a second threshold, the server determines that the corresponding information satisfies the preset placement conditions. The priorities of the placement conditions may be set by the display location publisher or the server, which is not restricted by the present disclosure.

For example, the server may determine whether the display location satisfies the preset to-be-placed condition according to the display location information by any of the following methods.

In a first method, the server matches the display location information with each of the preset to-be-placed conditions. If a percentage of a number of successfully matched preset to-be-placed conditions to a total number of the preset to-be-placed conditions is higher than a third threshold, the server determines that the corresponding display location satisfies the preset to-be-placed conditions.

In a second method, the server ranks priorities of the to-be-placed conditions from high to low and matches the display location information to the to-be-placed conditions in an order of descending priorities of the to-be-placed conditions. When a number of successfully matched preset to-be-placed conditions is higher than a fourth threshold, the server determines that the corresponding display location satisfies the preset to-be-placed conditions. The priorities of the to-be-placed conditions may be set by the placement information provider or the server, which is not restricted by the present disclosure.

For instance, information submitted by a placement information provider A to the server includes the following to-be-placed conditions: a website where a display location locates is a portal website, a minimum historical successful promotion ratio is 40%, and a minimum traffic volume of the display location is 100 M. Display location information of a display location B obtained by the server is as follows: a common website, a traffic volume of the display location is 120 M, and a historical successful promotion ratio is 50%. A preset matching ratio threshold between the information and the display location is 50%. In this example, the matching ratio between the placement information and the display location is 66%, which is higher than the preset matching ratio threshold. Thus, even though the display location B is not the portal website required by the placement information provider A, the server may still permit the placement information provided by the placement information provider A to be placed at the display location B. This is simply an example and shall not be used to restrict the actual operations.

In one example embodiment of the present disclosure, after determining the information to be placed at the corresponding display location, the server obtains access traffic volume and user access types of the corresponding display location during a preset time period, and updates the value index of the display location according to the access traffic volume and the user access types during the preset time period;

Alternatively, or in addition, the server obtains transaction information of the subject corresponding to the placement information during the preset time period and updates the investment index of the placement information according to the transaction information of the subject of the placement information during the preset time period. The server may further select placement information provided by the placement information provider to be placed at the corresponding display location according to the updated value index and/or the investment index.

The server may also recommend more appropriate placement information or display location to the display location publisher or the placement information provider respectively according to the obtained display location information or subject of the placement information.

For instance, after the placement information provided by a placement information provider C has been placed at a display location D for a period of time, a transaction amount of the subject corresponding the placement information is lower than a threshold, the server may notify the placement information provider C of an unsuitability of placing the placement information at the display location D and recommend one or more other display locations satisfying the corresponding conditions.

The server may obtain access traffic volume and user access types of the corresponding display location during a preset time period, and return the obtained access traffic volume and user access types to the client device of the display location publisher. The client device of the display location publisher may provide the preset placement conditions based on the received access traffic volume and user access types.

Alternatively, or in addition, the server may obtain the transaction information of the subject corresponding to the placement information during a preset time period and provide the obtained transaction information of the subject corresponding to the placement information during the preset time period to the client device of the placement information provider. The client device of the placement information provider may set the to-be-placed conditions according to the received transaction information of the subject corresponding to the placement information.

For example, when the access traffic of the display location grows and the proportion of users clicking and viewing among all user access types is relatively higher than a threshold (e.g., above 50%), the display location publisher may raise the placement investment parameter, the historical transaction amount, etc. of the subject corresponding to the placement information allowed to be placed at the display location. Correspondingly, as the transaction amount of the subject corresponding to the placement information grows, the placement information provider may lower the placement investment parameter of the placement information.

The present techniques do not restrict information sources for the server to conduct statistics of assess traffic and other information of the display location during the preset time period. For example, the server, after determining a corresponding relationship between the display location and the placement information, may locally store the access traffic of the corresponding display location, the user access types, and the transaction information of the subject corresponding to the placement information. When the server needs to collect statistics of the access traffic and other information of the corresponding display location during the preset time period, the server may collect statistics according to the locally stored information. Alternatively, when the server needs to collect statistics, the server may also obtain relevant data from the database server. The database server may include website servers corresponding to websites where respective display locations are located, website servers corresponding to the subjects corresponding to corresponding placement information, etc.

In the present disclosure, the server receives the display location publishing information, determines the value index of the corresponding display location according to the received display location publishing information. When the server receives the information placement request, the server determines the investment index of the corresponding placement information according to the received information placement request, compares the value index of the display location with the investment index of the placement information, and places the placement information at a corresponding display location according to the comparison result, thereby improving the efficiency of information placement and optimizing resource deployment.

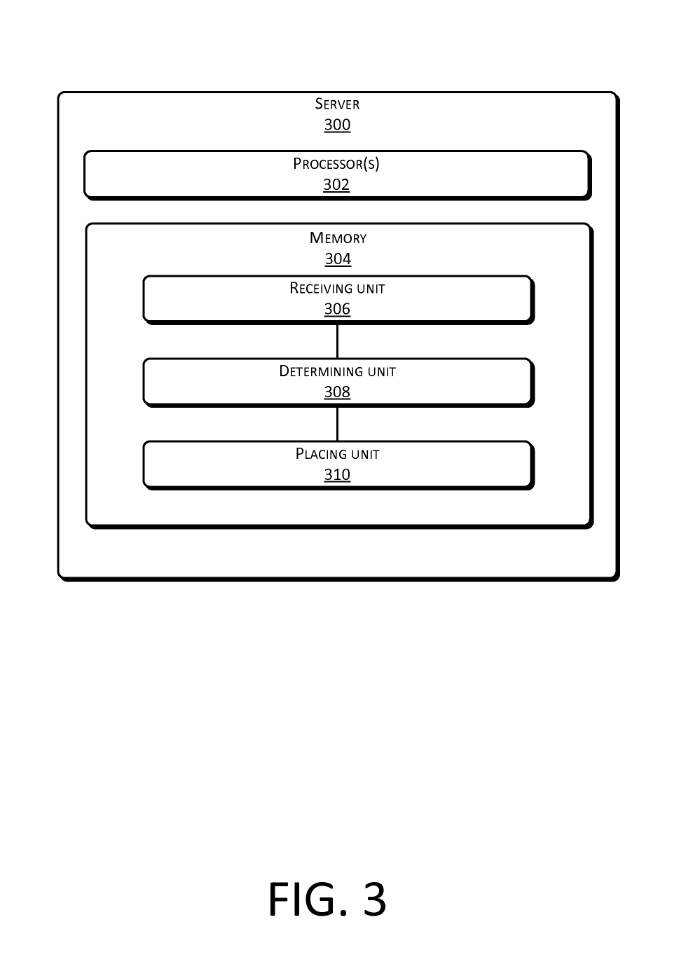

Based on techniques similar to those described in the above example methods, the present disclosure also provides an example server 300 for automatic information placement as shown in FIG. 3. The server 300 includes one or more processor(s) 302 and memory 304. The memory 304 is an example of computer-readable media. As used herein, “computer-readable media” includes computer storage media and communication media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage apparatus, or any other non-transmission medium that can be used to store information for access by a computing apparatus. In contrast, communication media may embody computer-readable instructions, data structures, program modules, or other data in a modulated data signal, such as a carrier wave. As defined herein, computer storage media does not include communication media.

The memory 304 may store therein program units or modules and program data. In the example of FIG. 3, the memory 302 may store therein a receiving unit 306, a determining unit 308, and a placing unit 310.

The receiving unit 306 receives display location publishing information and information placement request.

The determining unit 308 determines a value index of the corresponding display location according to the received display location publishing information and an investment index of the corresponding placement information according to the received information placement request.

The placing unit 310 compares the value index of the display location with the investment index of the placement information and places the placement information at a corresponding display location according to a comparison result.

For example, the determining unit 308 may also obtain display location information carried in the display location publishing information, obtain historical information of the corresponding display location according to the display location information carried in the display location publishing information, and determine the value index of the corresponding display location according to the historical information of the display location and the display location information.

The display location information may include one or any combination of the following information including a size, a type, traffic, and other information of the display location. The historical information of the display location may include one or any combination of the following information including historical access traffic of the display location, a user access type, historical transaction information of the subject corresponding to the placement information placed at the display location, a historical placement investment parameter of the corresponding information, etc.

For example, the determining unit 308 may also obtain the placement information and the placement investment parameter of the placement information carried in the information placement request, obtain historical information of the placement information according to the placement information, and determine the investment index of the placement information according to the historical information of the placement information, the placement information, and the placement investment parameter of the placement information.

The placement information includes one or any combination of the following information including a name of a subject corresponding to the placement information, a type of the subject corresponding to the placement information, a price of the subject corresponding to the placement information, etc. The historical information of the placement information includes one or any combination of the following information including historical transaction information of the subject corresponding to the placement information, a historical placement investment parameter of the corresponding information, etc.

The display location publishing information may further carry one or more preset placement conditions. The one or more preset placement condition may include one or any combination of the following including a minimum placement investment parameter, a minimum historical transaction amount, and a category of the subject corresponding to the information.

For example, the placing unit 310 may match the placement information to each of the preset placement conditions. If a percentage of a number of successfully matched preset placement conditions to a total number of the preset placement conditions is higher than a threshold, the placing unit 310 determines that the corresponding placement information satisfies the preset placement conditions.

For instance, the placing unit 310 may rank priorities of the placement conditions from high to low and matches the placement information to the placement conditions in an order of descending priorities of the placement conditions. When a number of successfully matched preset placement conditions is higher than a threshold, the server determines that the corresponding placement information satisfies the preset placement conditions.

The information placement request may further carry one or more preset to-be-placed conditions. The one or more preset to-be-placed conditions may include one or any combination of the following including a maximum placement investment parameter, a traffic volume of the display location, a size of the display location, etc.

For example, the placing unit 310, after determining that the corresponding display location satisfies the preset to-be-placed conditions according to the display location information carries by the display location publishing information, compares the value index of the display location that satisfies the preset to-be-placed conditions with the investment index of the placement information.

The placing unit 310 may match the display location information with each of the preset to-be-placed conditions. If a percentage of a number of successfully matched preset to-be-placed conditions to a total number of the preset to-be-placed conditions is higher than a third threshold, the placing unit 310 determines that the corresponding display location satisfies the preset to-be-placed conditions.

The placing unit 310 may also rank priorities of the to-be-placed conditions from high to low and matches the display location information to the to-be-placed conditions in an order of descending priorities of the to-be-placed conditions. When a number of successfully matched preset to-be-placed conditions is higher than a fourth threshold, the placing unit 310 determines that the corresponding display location satisfies the preset to-be-placed conditions.

For example, after the placing unit 310 places the placement information at the corresponding display location, the determining unit 308 may update the value index of the display location according to the access traffic volume and the user access types of the corresponding display location during the preset time period.

The placing unit 310 may further place the placement information at the corresponding display location according to the updated value index.

Alternatively, or in addition to, after the placing unit 310 places the placement information at the corresponding display location, the determining unit 308 may update the investment index of the placement information according to the transaction information of the subject corresponding to the placement information during the preset time period.

The placing unit 310 may further place the placement information at the corresponding display location according to the updated investment index.

The determining unit 308 may further send to the server database a request of obtaining historical information that includes an identification of the subject corresponding to the placement information, and receive the historical information of the placement information from the server database.

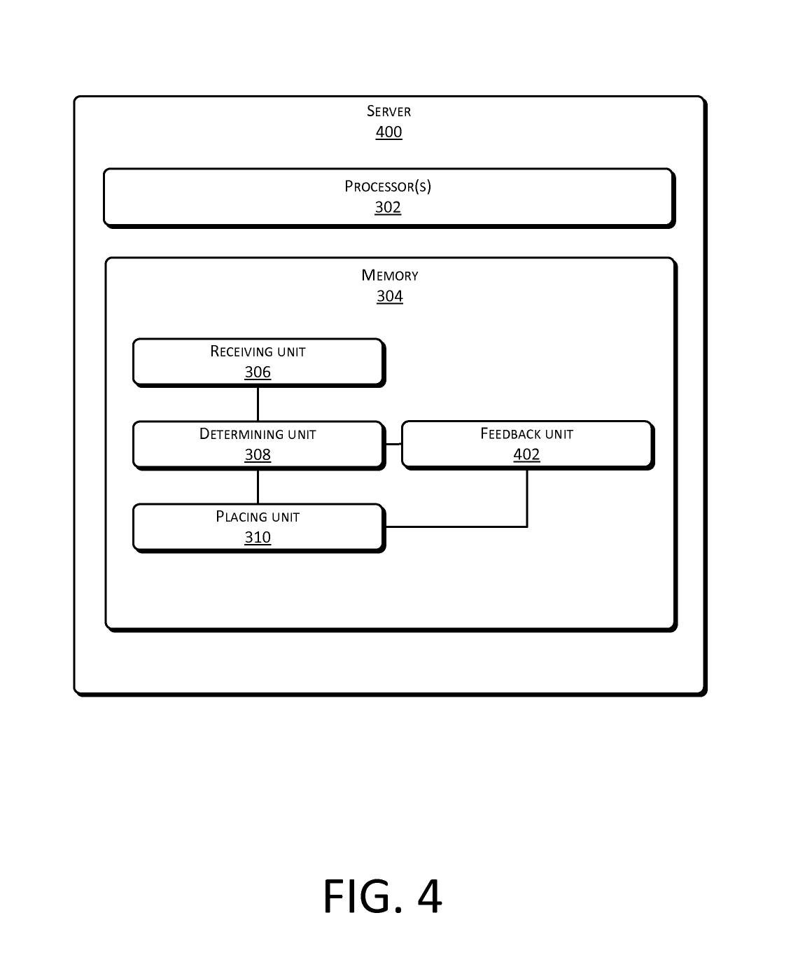

FIG. 4 shows another example server 400 for automatic information placement. The server 400 may further include a feedback unit 402 based on the system 300. After the placing unit 310 places the placement information at the corresponding display location, the feedback unit 402 obtains the access traffic volume and the user access types of the corresponding display location during the preset time period, and returns the obtained access traffic volume and the user access types to the client device of the display location publisher. The client device of the display location publisher may provide the preset placement conditions based on the received access traffic volume and the user access types.

Alternatively, or in addition to, after the placing unit 310 places the placement information at the corresponding display location, the feedback unit 402 obtains the transaction information of the subject corresponding to the placement information during the preset time period and provides the obtained transaction information of the subject corresponding to the placement information during the preset time period to the client device of the placement information provider. The client device of the placement information provider may set the to-be-placed conditions according to the received transaction information of the subject corresponding to the placement information.

One of ordinary skill in the art would appreciate that the present techniques may be implemented in the form of software and necessary general-purpose hardware platform or hardware. The present techniques may be implemented in the form of software including computer-executable instructions stored on one or more computer storage media. The computer-executable instructions enable one or more computing devices (such as personal computers, servers, or network devices) including one or more processors to implement the method as described in the present disclosure.

One of ordinary skill in the art would also appreciate that the FIGs are example figures of one or more example embodiments. The modules or units or sequences in the FIGs may be not necessarily required to implement the present techniques.

One of ordinary skill in the art would also appreciate that the units in the apparatus of the example embodiments of the present disclosure may be distributed in the apparatuses as shown in the FIGs to perform the present techniques. Alternatively, the units may have variations and locate in one or more apparatuses different from those described in the above example embodiments. The units in the example embodiments may be merged into one unit or further divided into several sub-units.

The numerals of the example embodiments in the present disclosure are solely for the purpose of description and do not represent any preference of one embodiment to another.

The present disclosure provides only several example embodiments of the present disclosure and shall not be limited to such embodiments. Any variation conceivable by one of ordinary skill in the art shall fall into the protection scope of the present disclosure.

What is claimed is:

1. A method comprising:
determining one or more value indexes of one or more display locations according to one or more display location publishing information respectively;
determining one or more investment indexes of one or more placement information according to one or more information placement requests respectively; and
comparing one or more of the value indexes and the investment indexes to determine a respective display location for respective placement information.

2. The method as recited in claim 1, wherein the determining one or more value indexes of one or more display locations respectively comprises:
receiving respective display location publishing information, the respective display location publishing information including respective display location information of the respective display location, the respective display location information including a size, a type, or traffic of the respective display location;
obtaining historical information of the respective display location, the historical information of the respective display location including historical traffic of the respective display location, a user access type of the respective display location, historical transaction information of a subject of placement information placed at the respective display location, or a historical placement investment parameter; and
determining a value index of the respective display location according to the respective display location information and the historical information of the respective display location.

3. The method as recited in claim 2, wherein the obtaining historical information of the respective display location comprises:
sending a request of historical information of the respective display location to a server database, the request of historical information of the respective display location including an identification of the respective display location; and
receiving the historical information of the respective display location from the server database.

4. The method as recited in claim 1, wherein the determining one or more investment indexes of one or more placement information respectively comprises:
receiving a respective information placement request, the respective information placement request including the respective placement information and a placement investment parameter of the respective placement information;
obtaining historical information of the respective placement information including historical information of a subject of the respective placement information or a historical placement investment parameter of the respective placement information; and
determining an investment index of the respective placement information according to the historical information of the respective placement information, the respective placement information, and the placement investment parameter of the respective placement information.

5. The method as recited in claim 4, wherein the obtaining historical information of the respective placement information comprises:
sending a request of historical information of the respective placement information to a server database, the request of historical information of the respective placement information including an identification of the respective placement information; and
receiving the historical information of the respective placement information from the server database.

6. The method as recited in claim 1, wherein:
respective display location publishing information includes one or more preset placement conditions, the one or more preset placement conditions including a minimum placement investment parameter, a minimum historical transaction amount, or a category of a subject of respective placement information; and
the comparing one or more of the value indexes and the investment indexes to determine the respective display location for the respective placement information comprises:
determining placement information that satisfies the one or more preset placement conditions; and
comparing an investment index of the placement information that satisfies the one or more preset placement conditions with the one or more value indexes of the one or more display locations.

7. The method as recited in claim 6, wherein the determining the placement information that satisfies the one or more preset placement conditions comprises:
if a percentage of a number of successfully matched preset placement conditions of the placement information to a total number of the preset placement conditions is higher than a first threshold, determining that the placement information satisfies the one or more preset placement conditions.

8. The method as recited in claim 6, wherein the determining the placement information that satisfies the one or more preset placement conditions comprises:
ranking priorities of the one or more preset placement conditions from high to low;
matching the placement information to the one or more preset placement conditions in an order of descending priorities; and
when a number of successfully matched preset placement conditions is higher than a second threshold, determining that the placement information satisfies the one or more preset placement conditions.

9. The method as recited in claim 1, wherein:
respective information placement request includes one or more preset to-be-placed conditions, the one or more preset to-be-placed placement conditions including a maximum placement investment parameter, a traffic volume of the respective display location, or a size of the respective display location; and
the comparing one or more of the value indexes and the investment indexes to determine the respective display location for the respective placement information comprises:
determining display location that satisfies the one or more preset to-be-placed conditions according to respective display location information included in the respective display location publishing information; and
comparing a value index of the display location that satisfies the one or more preset to-be-placed conditions with the one or more investment indexes of the one or more placement information.

10. The method as recited in claim 9, wherein the determining the respective display location that satisfies the one or more preset to-be-placed conditions comprises:
if a percentage of a number of successfully matched preset to-be-placed conditions of the respective display location to a total number of the preset to-be-placed conditions is higher than a third threshold, determining that the display location satisfies the one or more preset to-be-placed conditions.

11. The method as recited in claim 9, wherein the determining the respective display location that satisfies the one or more preset to-be-placed conditions comprises:
ranking priorities of the one or more preset to-be-placed conditions from high to low;
matching the respective display location to the one or more preset to-be-placed conditions in an order of descending priorities; and
when a number of successfully matched preset to-be-placed conditions is higher than a fourth threshold, determining that the display location satisfies the one or more preset to-be-placed conditions.

12. The method as recited in claim 1, further comprising placing the respective placement information at the respective display location according to a result of the comparing.

13. The method as recited in claim 12, further comprising:
obtaining an access traffic volume and a user access type of the respective display location during a first preset time period;
returning the access traffic volume and the user access type during the first preset time period to a client device of a display location publisher; and
providing an interface to the display location publisher to set one or more placement conditions according to the access traffic volume and the user access type.

14. The method as recited in claim 12, further comprising:
obtaining transaction information of a subject of the respective placement information during a second preset time period;
returning the transaction information of the subject of the respective placement information during the second preset time period to a client device of a placement information provider; and
providing an interface to the placement information provider to set one or more to-be-placed conditions according to the transaction information of the subject of the respective placement information during the second preset time period.

15. The method as recited in claim 1, further comprising:
obtaining an access traffic volume and a user access type of the respective display location during a third preset time period;
updating the value index of the respective display location according to the access traffic volume and the user access type during the third preset time period; and
updating the respective placement information to be placed at the respective display location according to the updated value index of the respective display location.

16. The method as recited in claim 1, further comprising:
obtaining transaction information of a subject of the respective placement information during a fourth preset time period;
updating the investment index of the respective placement information according to the transaction information of the subject of the respective placement information during the fourth preset time period; and
updating the respective display location for placing the respective placement information according to the updated investment index of the respective placement information.

17. A server comprising:
a receiving unit that receives one or more display location publishing information and one or more information placement requests;
a determining unit that determines one or more value indexes of the one or more display locations and one or more investment indexes of the one or more placement information respectively; and
a placing unit that compares one or more of the value indexes and the investment indexes to determine a respective display location for respective placement information.

18. The server as recited in claim 17, further comprising a feedback unit that obtains an access traffic volume and a user access type of the respective display location during a first preset time period and returns the access traffic volume and the user access types to a client device of a display location publisher.

19. One or more computer storage media having stored thereon computer executable instructions that are executable by one or more computing devices to perform actions comprising:
determining one or more value indexes of one or more display locations;
determining one or more investment indexes of one or more placement information; and
comparing one or more of the value indexes and the investment indexes to determine a respective display location for respective placement information.

20. The one or more computer storage media as recited in claim 19, wherein the actions further comprise:
placing the respective placement information at the respective display location according to a result of the comparing.
